(19) United States
(12) Patent Application Publication
(10) Pub. No.: US 2022/0162371 A1
(43) Pub. Date: May 26, 2022

(54) TWO-COMPONENT POLYURETHANE COATINGS HAVING IMPROVED POT LIFE WITHOUT A LOSS OF WEATHERING RESISTANCE

(71) Applicant: Covestro Intellectual Property GmbH & Co. KG, Leverkusen (DE)

(72) Inventors: Florian Golling, Düsseldorf (DE); Andreas Hecking, Langenfeld (DE)

(21) Appl. No.: 17/601,508

(22) PCT Filed: Apr. 2, 2020
(86) PCT No.: PCT/EP2020/059399

§ 371 Date: Oct. 5, 2021

(30) Foreign Application Priority Data
Apr. 9, 2019 (EP) 19168030.5

(51) Int. Cl. C08G 18/10; C08G 18/73; C08G 18/28; C08G 18/77; C08G 18/24; C08G 18/62; C08L 75/04

(52) U.S. Cl. CPC C08G 18/10; C08G 18/73; C08G 18/289; C08G 18/778; C08G 2190/00; C08G 18/6225; C08L 75/04; C08G 2150/00; C08G 2170/00; C08G 18/246

(57) ABSTRACT

The present invention relates to a 2-component system containing at least one specific N-, S-, O- and Si-containing compound. The invention further relates to a process for preparing silicon-containing polyurethanes, comprising reacting the first component with the second component of the 2-component system according to the present invention, and to the silicon-containing polyurethanes obtained therefrom. In addition, the invention relates to the use of the 2-component system according to the present invention for the production of coating, sealants or adhesives.

The present invention relates to a 2-component system containing at least one specific N-, S-, O- and Si-containing compound. The invention further relates to a process for preparing silicon-containing polyurethanes, comprising reacting the first component with the second component of the 2-component system according to the present invention, and to the silicon-containing polyurethanes obtained therefrom. In addition, the invention relates to the use of the 2-component system according to the present invention for the production of coating, sealants or adhesives.

Silicon-containing 2-component polyurethanes are known in the prior art. For example, WO 2017/042177 A1 describes a coating system based on a thioallophanate containing two NCO functionalities and a silane group. This crosslinker is incorporated into a polyurethane clearcoat formulation based on a polyisocyanate and a polyacrylate polyol. EP 2 641 925 A1 describes the synthesis of silane-terminated prepolymers and their use in 2K PU formulations. WO 2014/037265 A1 describes the synthesis of thiourethanes which crosslink with themselves. The self-crosslinking of the silane-terminated prepolymer as a coating material is described. However, these documents merely disclose compositions with regard to good scratch resistance.

It was an object of the present invention to provide a silicon-containing 2-component polyurethane coating having equivalent weathering properties as conventional, non-silicon-containing 2-component polyurethane composition.

The inventors of the present invention have additionally surprisingly found that the systems according to the present invention can be used to obtain coating material having an extended pot life and improved scratch resistance.

In a first aspect, the invention relates to a 2-component system comprising or consisting of

a first component, which comprises or consists of
A1) at least one compound having at least one Zerewitinoff-active group;
B1) optionally at least one catalyst;
C1) optionally at least one solvent; and
D1) optionally at least one additive,
and
   a second component, which comprises or consists of
A2) at least one polyisocyanate; and
B2) at least one of the following compounds of the formula (I):

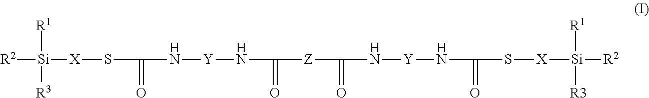

where
R¹ to R³ each independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably in each case alkyl radicals which have up to 6 carbon atoms and/or alkoxy radicals which have up to 6 carbon atoms and may contain up to 3 oxygen atoms, particularly preferably in each case methyl, methoxy and/or ethoxy, with the proviso that at least one of the radicals R¹, R² and R³ is joined to the silicon atom via an oxygen atom,
X independently at each instance are identical or different, saturated or unsaturated, linear or branched, aliphatic or cycloaliphatic or optionally substituted aromatic or araliphatic radicals which have up to 6 carbon atoms, preferably linear alkyl radicals having 1 to 4 carbon atoms, particularly preferably is a propylene radical (—CH₂—CH₂—CH₂—);
Y independently at each instance are identical or different, saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably selected from isophoronyl, pentamethylene, hexamethylene, biscyclohexylmethylene, toluidenyl or methylenediphenylene; and
Z is a structural unit which is derived from an at least difunctional polyol having a number-average molecular weight Mₙ of 270 to 22 000 g/mol, preferably of 500 to 18 000 g/mol and particularly preferably of 800 to 12 000 g/mol;
   or
   is a polyhydric alcohol and/or ether alcohol or ester alcohol containing 2 to 14 carbon atoms, preferably 4 to 10 carbon atoms;
   C2) optionally at least one solvent;
   D2) optionally at least one compound which differs from the compound of formula (I) and is obtained by reacting at least one isocyanate group with a secondary amine containing a silane group.

In a second aspect, the present invention relates to a process for preparing silicon-containing polyurethanes, comprising reacting the first component with the second component of the 2-component system according to the present invention.

In a third aspect, the present invention relates to silicon-containing polyurethanes obtainable by the process of the present invention.

Lastly, the invention in a fourth aspect relates to the use of the 2-component system according to the present invention for the production of coating, sealants or adhesives.

“At least one”, as used herein, refers to 1 or more, for example 2, 3, 4, 5, 6, 7, 8, 9 or more. In connection with constituents of the compounds described herein, this indication does not refer to the absolute amount of molecules, but rather to the nature of the constituent. “At least one catalyst” therefore means, for example, that only one type of catalyst or a plurality of different types of catalysts may be present, without specifying the amount of the individual compounds.

Numerical values specified herein without decimal places each refer to the full value specified with one decimal place. For example, “99%” signifies “99.0%”.

The expressions “approximately”, “approx.” or “around”, in connection with a numerical value, refer to a variance of ±10%, based on the specified numerical value, preferably ±5%, particularly preferably ±1%.

The expression “essentially free of” means that the respective compound may be present in principle, but is in that case present in an amount which does not impair the function of the other components. In the context of the present invention, the property “essentially free of” a particular compound is therefore considered preferably to be a total weight of less than 0.1% by weight, more preferably less than 0.001% by weight, in particular free of said compound, based on the total weight of the composition or of the system.

Numerical ranges given in the format “in/from x to y” include the values stated. If two or more preferred numerical ranges are given in this format, it is understood that all ranges arising from the combination of the various end points are likewise encompassed.

Figures concerning molecular weight relate to the weight-average molecular weight in g/mol unless the number-average molecular weight is explicitly stated. Molecular weights are preferably determined by means of GPC using polystyrene standards.

The invention relates in particular to:
1. A 2-component system comprising or consisting of
   a first component, which comprises or consists of
   A1) at least one compound having at least one Zerewitinoff-active group;
   B1) optionally at least one catalyst;
   C1) optionally at least one solvent; and
   D1) optionally at least one additive,
   and
      a second component, which comprises or consists of
   A2) at least one polyisocyanate; and
   B2) at least one of the following compounds of the formula (I):

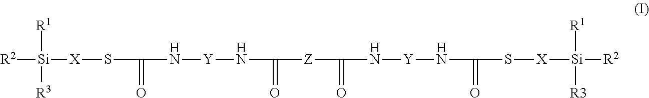

where
R¹ to R³ each independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably in each case alkyl radicals which have up to 6 carbon atoms and/or alkoxy radicals which have up to 6 carbon atoms and may contain up to 3 oxygen atoms, particularly preferably in each case methyl, methoxy and/or ethoxy, with the proviso that at least one of the radicals R¹, R² and R³ is joined to the silicon atom via an oxygen atom,
X independently at each instance are identical or different, saturated or unsaturated, linear or branched, aliphatic or cycloaliphatic or optionally substituted aromatic or araliphatic radicals which have up to 6 carbon atoms, preferably linear alkyl radicals having 1 to 4 carbon atoms, particularly preferably is a propylene radical (—CH₂—CH₂—CH₂—);
Y independently at each instance are identical or different, saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably selected from isophoronyl, pentamethylene, hexamethylene, biscyclohexylmethylene, toluidenyl or methylenediphenylene; and
Z is a structural unit which is derived from an at least difunctional polyol having a number-average molecular weight Mₙ of 270 to 22 000 g/mol, preferably of 500 to 18 000 g/mol and particularly preferably of 800 to 12 000 g/mol;
   or
   is a polyhydric alcohol and/or ether alcohol or ester alcohol containing 2 to 14 carbon atoms, preferably 4 to 10 carbon atoms;
   C2) optionally at least one solvent;
   D2) optionally at least one compound which differs from the compound of formula (I) and is obtained by reacting at least one isocyanate group with a secondary amine containing a silane group.
2. The 2-component system according to item 1, characterized in that the at least one compound A1 is selected from polyols, polyamines, polyether polyols, polyester polyols, polyurethane polyols, polysiloxane polyols, polycarbonate polyols, polyether polyamines, polybutadiene polyols, polyacrylate polyols and polymethacrylate polyols and copolymers thereof, preferably the at least one compound A1 is selected from polyacrylate polyols and polymethacrylates and copolymers thereof, polyester polyols and polyurethanes, more preferably the at least one compound A1 is a polyol polyacrylate polyol or polymethacrylate and a copolymer thereof.
3. The 2-component system according to item 1 or 2, characterized in that the at least one catalyst B1 is selected from the class of tin catalysts, bismuth catalysts, zinc catalysts, zirconium catalysts and amine bases, more preferably the at least one catalyst B1 is selected from metal salts such as zinc chloride, zinc 2-ethylcaproate, tin(II) octanoate, tin(II) ethylcaproate, dibutyltin(IV) dilaurate, zirconium(IV) isopropoxide, zirconium(IV) n-butoxide, zirconium(IV) 2-ethylhexanoate, zirconyl octanoate, bismuth(III) 2-ethylhexanoate and bismuth(III) octoate.
4. The 2-component system according to one of the preceding items, characterized in that the at least one solvent C1 is selected from aromatic solvents and aliphatic solvents, preferably from esters, ethers, benzene and its derivatives, more preferably the at least one solvent C1 is selected from butyl acetate, 1-methoxy-2-propyl acetate, 3-methoxy-1-butyl acetate, ethyl acetate, dibasic esters, propylene n-butyl ether, methyl ethyl ketone, toluene, xylene, solvent naphtha (hydrocarbon mixture), and mixtures thereof.
5. The 2-component system according to one of the preceding items, characterized in that the at least one additive D1 is selected from UV stabilizers, antioxidants and leveling agents, or mixtures thereof, more preferably the at least one additive is selected from UV stabilizers based on cyanoacrylates, oxalanilides, benzophenones, benzotriazoles, triazines, HALS amines (hindered amine light stabilizers) and silicone-free and silicone-containing leveling agents, the UV stabilizers are particularly preferably Tinuvin 292 and Tinuvin 1130 and the leveling agents BYK 141 and BYK 311.
6. The 2-component system according to one of the preceding items, characterized in that the at least one polyisocyanate A2 is selected from di- or triisocyanates, such as butane 1,4-diisocyanate, pentamethylene diisocyanate, hexamethylene diisocyanate, 4-isocyanatomethyloctane 1,8-diisocyanate, 4,4′-methylenebis(cyclohexyl isocyanate), decamethylene 1,10-diisocyanate, 3,5,5-trimethyl-1-isocyanato-3-isocyanatomethylcyclohexane, 1,3- and 1,4-bis(isocyanatomethyl)cyclohexane, isophorone diisocyanate, naphthalene 1,5-diisocyanate, diisocyanatodiphenylmethane, such as 2,2′-, 2,4′- and 4,4′-MDI or mixtures thereof, diisocyanatomethylbenzene, such as tolylene 2,4- and 2,6-diisocyanate, and technical grade mixtures of the two isomers, and 1,3- and/or 1,4-bis(isocyanatomethyl)benzene, 3,3′-dimethyl-4,4′-biphenyl diisocyanate, paraphenylene 1,4-diisocyanate and cyclohexyl diisocyanate and the oligomers of higher molecular weight which are obtainable individually or in a mixture from the above and have biuret, uretdione, isocyanurate, iminooxadiazinedione, allophanate, urethane and carbodiimide/uretonimine structural units, preferably polyisocyanates based on aliphatic and cycloaliphatic diisocyanates are used, more preferably the at least one polyisocyanate A2 is selected from hexamethylene diisocyanate, pentamethylene diisocyanate and isophorone diisocyanate.
7. The 2-component system according to one of the preceding items, characterized in that D2 is selected from
   i) at least one compound of the formula (II)

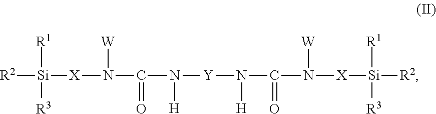

where
R¹, R² and R³ each independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably in each case alkyl radicals which have up to 6 carbon atoms and/or alkoxy radicals which have up to 6 carbon atoms and may contain up to 3 oxygen atoms, particularly preferably in each case methyl, methoxy and/or ethoxy, with the proviso that at least one of the radicals R¹, R² and R³ is joined to the silicon atom via an oxygen atom,
X is a linear or branched organic radical having up to 6 carbon atoms, preferably a linear alkyl radical having 1 to 4 carbon atoms, particularly preferably a propylene radical (—CH₂—CH₂—CH₂—) and
Y is a linear or branched, aliphatic or cycloaliphatic radical having 4 to 18 carbon atoms,
W independently at each instance are a formyl or acetyl group or else a COO group having a radical G, G in this case may be mono-, di-, tri- or tetrafunctional and is a linear or branched, aliphatic or cycloaliphatic radical or a connecting unit derived therefrom having 4 to 18 carbon atoms or an optionally substituted aromatic or araliphatic radical, and/or
ii) at least one compound of the formula (III)

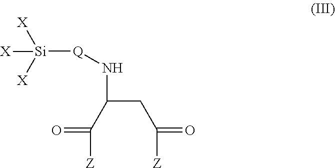

where
X independently at each instance is selected from alkoxy or alkyl radicals, or two radicals X together with the silicon atom to which they are bonded form an Si-substituted hydrocarbon ring, each having up to 10 carbon atoms, with the proviso that the Si atom has at least one alkoxy radical,
Q is a difunctional linear or branched aliphatic radical having up to 10 carbon atoms, preferably is —CH₂— or —(CH₂)₃—, in particular is —(CH₂)₃—; and
Z at each instance is an alkoxy radical having 1 to 10 carbon atoms.
8. The 2-component system according to one of the preceding items. characterized in that B2 preferably has an isocyanate content of less than 2%, more preferably has an isocyanate content of less than 1%.
9. The 2-component system according to one of the preceding items, characterized in that the constituents of the first component parts by weight of A1 and parts by weight of B1 are present preferably in a weight ratio of 0.5 to 8, more preferably in a weight ratio of 0.8 to 4, in relation to the constituents parts by weight of C1 and parts by weight of D1.
10. The 2-component system according to one of the preceding items, characterized in that the constituents of the second component parts by weight of A2 and parts by weight of B2 are present in a weight ratio of 0.5 to 10, more preferably in a weight ratio of 1 to 8, to the constituents parts by weight of C2 and parts by weight of D2.
11. The 2-component system according to one of the preceding items, characterized in that the constituents of the first component parts by weight of A1, and optionally parts by weight of B1, parts by weight of C1 and parts by weight of D1, are present in a weight ratio of 0.6 to 11, more preferably are present in a weight ratio of 0.8 to 8, to the constituents of the second component, parts by weight of A2, parts by weight of B2 and optionally parts by weight of C2 and parts by weight of D2.
12. A process for preparing silicon-containing polyurethanes, comprising reacting the first component with the second component of the 2-component system according to the present invention.
13. Silicon-containing polyurethanes obtainable by the process according to item 12.
14. The use of the 2-component system according to the present invention for the production of coating, sealants or adhesives.

The 2-component system contains a first component which contains at least one compound having at least one Zerewitinoff-active group, also referred to hereinafter as compound A1.

All compounds known to those skilled in the art and containing at least one NCO-reactive group having at least one Zerewitinoff-active group are suitable for this compound. Particularly suitable compounds have an average OH or NH functionality of at least 1.5. These may, for example, be diols (e.g. ethane-1,2-diol, propane-1,3- or -1,2-diol, butane-1,4-diol), triols (e.g. glycerol, trimethylolpropane) and tetraols (e.g. pentaerythritol), polyamines, but also polyhydroxyl compounds such as polyether polyols, polyester polyols, polyurethane polyols, polysiloxane polyols, polycarbonate polyols, polyether polyamines, polybutadiene polyols, polyacrylate polyols and/or polymethacrylate polyols and copolymers thereof, called polyacrylate polyols hereinafter.

In a preferred embodiment, the compound A1 is a polyhydroxyl compound. The polyhydroxyl compounds preferably have weight-average molecular weights Mw of >500 g/mol, measured by means of gel permeation chromatography (GPC) against a polystyrene standard, particularly preferably between 800 and 100 000 g/mol, in particular between 1000 and 50 000 g/mol. The polyhydroxyl compounds preferably have an OH number of 30 to 400 mg KOH/g, especially between 100 and 300 KOH/g. The hydroxyl number (OH number) indicates how many mg of potassium hydroxide are equivalent to the amount of acetic acid bound by 1 g of substance in the acetylation. In the determination, the sample is boiled with acetic anhydride/pyridine, and the acid formed is titrated with potassium hydroxide solution (DIN 53240-2 2:2007-11).

The glass transition temperatures, measured with the aid of DSC measurements in accordance with DIN EN ISO 11357-2-2:2014-07, of the polyhydroxyl compounds are preferably between −150 and 100° C., particularly preferably between −120° C. and 80° C. Polyether polyols are obtainable in a manner known per se by the alkoxylation of suitable starter molecules under base catalysis or by the use of double metal cyanide compounds (DMC compounds). Examples of suitable starter molecules for the preparation of polyether polyols are simple low molecular weight polyols, water, organic polyamines having at least two N—H bonds, or any mixtures of such starter molecules.

Preferred starter molecules for preparation of polyether polyols by alkoxylation, especially by the DMC method, are especially simple polyols such as ethylene glycol, 1,3-propylene glycol and butane-1,4-diol, hexane-1,6-diol, neopentyl glycol, 2-ethylhexane-1,3-diol, glycerol, trimethylolpropane, pentaerythritol, and low molecular weight hydroxyl-containing esters of such polyols with dicarboxylic acids of the kind specified hereinafter by way of example, or low molecular weight ethoxylation or propoxylation products of such simple polyols, or any desired mixtures of such modified or unmodified alcohols. Alkylene oxides suitable for the alkoxylation are in particular ethylene oxide and/or propylene oxide, which may be used in the alkoxylation in any order or also in a mixture.

Suitable polyester polyols are described, for example, in EP-A-0 994 1 17 and EP-A-1 273 640. Polyester polyols can be prepared in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. In addition, it is also possible to polycondense hydroxycarboxylic acid derivatives, for example lactic acid, cinnamic acid or hydroxycaproic acid, to give polyester polyols. However, it is also possible to use polyester polyols of oleochemical origin. Such polyester polyols can be prepared, for example, by full ring-opening of epoxidized triglycerides of an at least partly olefinically unsaturated fatty acid-containing fat mixture with one or more alcohols having 1 to 12 carbon atoms and by subsequent partial transesterification of the triglyceride derivatives to alkyl ester polyols having 1 to 12 carbon atoms in the alkyl radical.

Suitable polyurethane polyols are preferably prepared by reaction of polyester polyol prepolymers with suitable di- or polyisocyanates and are described, for example, in EP-A-1 273 640. Suitable polysiloxane polyols are described, for example, in WO-A-01/09260, and the polysiloxane polyols cited therein can preferably be used in combination with further polyhydroxyl compounds, especially those having higher glass transition temperatures. The polyacrylate polyols that are very particularly preferred in accordance with the invention are generally copolymers and preferably have weight-average molecular weights Mw of between 1000 and 20 000 g/mol, especially between 1500 and 10 000 g/mol, measured in each case by means of gel permeation chromatography (GPC) against a polystyrene standard. The glass transition temperature of the copolymers is generally between −100 and 100° C., especially between −50 and 80° C. (measured by means of DSC measurements in accordance with DIN EN ISO 11357-2-2:2014-07).

Preferred poly(meth)acrylate polyols have an OH number of 60 to 250 mg KOH/g, especially between 70 and 200 mg KOH/g, and an acid number of between 0 and 30 mg KOH/g. The acid number here indicates the number of mg of potassium hydroxide which is used for neutralization of 1 g of the respective compound (DIN EN ISO 21 14).

The preparation of suitable poly(meth)acrylate polyols is known per se to those skilled in the art. They are obtained by free-radical polymerization of oleochemically unsaturated monomers having hydroxyl groups or by free-radical copolymerization of oleochemically unsaturated monomers having hydroxyl groups with optionally other oleochemically unsaturated monomers, for example ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or especially cyclohexyl acrylate and/or cyclohexyl methacrylate. Suitable olefinically unsaturated monomers having hydroxyl groups are especially 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and especially 4-hydroxybutyl acrylate and/or 4-hydroxybutyl methacrylate.

Further monomer units used for the polyacrylate polyols may be vinylaromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

Preferred as poly(meth)acrylate polyols is at least one difunctional polymeric polyol having a number-average molecular weight according to GPC (in g/mol), determined in accordance with DIN 55672:2016-03, in the range from 270 to 22 000 g/mol, preferably from 500 to 18 000 g/mol, particularly preferably from 800 to 12 000 g/mol.

The first component can further contain at least one catalyst which is suitable for catalyzing the reaction of the first component with the second component. Such catalysts are known to those skilled in the art. Tin catalysts, bismuth catalysts, zinc catalysts, zirconium catalysts and amine bases are suitable.

Especially suitable, for example, are zinc compounds such as zinc(II) stearate, zinc(II) n-octanoate, zinc(II) 2-ethyl-1-hexanoate, zinc(II) naphthenate, zinc chloride, zinc 2-ethylcaproate or zinc(II) acetylacetonate, tin compounds such as tin(II) n-octanoate, tin(II) 2-ethyl-1-hexanoate, tin(II) laurate, dibutyltin oxide, dibutyltin dichloride, dibutyltin diacetate, tin(II) ethylcaproate, dibutyltin(IV) dilaurate, dibutyltin dimaleate or dioctyltin diacetate, zirconium compounds such as zirconium(IV) 2-ethyl-1-hexanoate, zirconium(IV) isopropoxide, zirconium(IV) n-butoxide, zirconium(IV) 2-ethylhexanoate, zirconyl octanoate, zirconium(IV) neodecanoate, zirconium(IV) naphthenate or zirconium(IV) acetylacetonate, bismuth(III) 2-ethylhexanoate and bismuth(III) octoate.

The catalyst is preferably used in amounts of 0.01% to 0.5% by weight, more preferably in amounts of 0.03% to 0.3% by weight, based on the total weight of the compound A1 of the first component and A1 and B1 of the second component.

The first component can preferably also contain at least one solvent. In general, all solvents known to those skilled in the art in this field are suitable here. Especially suitable are aromatic and aliphatic solvents, preferably selected from butyl acetate, 1-methoxy-2-propyl acetate, 3-methoxy-1-butyl acetate, ethyl acetate, dibasic esters, propylene n-butyl ether, methyl ethyl ketone, toluene, xylene, solvent naphtha (hydrocarbon mixture) and also mixtures thereof.

The solvent is preferably present at 30% to 90% by weight, particularly preferably at 45% to 70% by weight, based on the total weight of the first component.

The first component can also optionally contain at least one additive. In general, all additives known to those skilled in the art in this field are suitable here. Preference is given here to UV stabilizers, antioxidants, leveling agents, fillers and/or pigments.

Suitable UV stabilizers can preferably be selected from the group consisting of piperidine derivatives such as 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives such as 2,4-dihydroxybenzophenone, 2-hydroxy-4-methoxybenzophenone, 2-hydroxy-4-octoxybenzophenone, 2-hydroxy-4-dodecyloxybenzophenone or 2,2′-dihydroxy-4-dodecyloxybenzophenone; benzotriazole derivatives such as 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(1-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides such as 2-ethyl-2′-ethoxyoxalanilide or 4-methyl-4′-methoxyoxalanilide; salicylic esters such as phenyl salicylate, 4-tert-butylphenyl salicylate, 4-tert-octylphenyl salicylate; cinnamic ester derivatives such as methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred UV stabilizers can be used either individually or in any desired combinations with one another. Particularly preferred UV stabilizers are available under the trade names Tinuvin 292 and Tinuvin 1130 from BASF.

Preferred UV absorbers are DL-alpha-tocopherol, tocopherol, cinnamic acid derivatives and cyanoacrylates.

Suitable UV absorbers are also sterically hindered amines (often also referred to as HALS compound or HAS compound-hindered amine (light) stabilizer), such as 2,2,6,6-tetramethylpiperidine, 2,6-di-tert-butylpiperidine or derivatives thereof, for example bis(2,2,6,6-tetramethyl-4-piperidyl) sebacate. These are available, for example, as Tinuvin® and Chimassorb® brands from BASF SE. Examples of N-alkylated radical scavengers include bis(1,2,2,6,6-pentamethyl-4-piperidinyl) [[3,5-bis(1,1-dimethylethyl)-4-hydroxyphenyl]methyl]butylmalonate (e.g. Tinuvin® 144 from BASF); a mixture of bis(1,2,2,6,6-pentamethyl-4-piperidinyl) sebacate and methyl(1,2,2,6,6-pentamethyl-4-piperidinyl) sebacate (e.g. Tinuvin 292 from BASF SE); or which are N-(o-alkylated), such as bis(2,2,6,6,-tetramethyl-1-(octyloxy)-4-piperidinyl) decanedioate, reaction products with 1,1-dimethylethyl hydroperoxide and octane (e.g. Tinuvin® 123 from BASF SE), and especially the HALS triazine “2-aminoethanol, reaction products with cyclohexane and peroxidized N-butyl-2,2,6,6-tetramethyl-4-piperidinamine-2,4,6-trichloro-1,3,5-triazine reaction product” (e.g. Tinuvin® 152 from BASF SE).

Optionally, one or more of the UV stabilizers, mentioned by way of example, of the first component are used preferably in amounts of 0.0001% to 3.0% by weight, particularly preferably 0.001% to 2% by weight, based on the total weight of the compound A1 of the first component and the compound A2 and B2 of the second component.

Further suitable antioxidants are preferably sterically hindered phenols, which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. These may be used either individually or in any desired combinations with one another as required.

Antioxidants are used in amounts of preferably 0.001% to 3.0% by weight, particularly preferably 0.02% to 2.0% by weight, calculated as the total amount of antioxidants used based on the total weight of the compound A1 of the first component and the compound A2 and B2 of the second component.

In order to improve the substrate wetting, suitable leveling agents may optionally be present, for example organically modified siloxanes, such as polyether-modified siloxanes, polyacrylates and/or fluorosurfactants. These leveling agents are used in amounts by preference of 0.01% by weight to 3% by weight, preferably 0.01% by weight to 2% by weight, particularly preferably 0.05% to 1.5% by weight, calculated as the total amount of leveling agents used based on the total weight of compound A1 of the first component. Preferred leveling agents are available commercially under the trade names BYK 141 and BYK 311 from Altana.

The second component comprises at least one polyisocyanate.

Polyisocyanates used here may in principle be any polyisocyanates known to those skilled in the art to be suitable for the preparation of polyisocyanate polyaddition products, especially polyurethanes, especially the group of the organic aliphatic, cycloaliphatic, araliphatic and/or aromatic polyisocyanates having at least two isocyanate groups per molecule and mixtures thereof. Examples of polyisocyanates of this kind are di- or triisocyanates, for example butane 1,4-diisocyanate, pentane 1,5-diisocyanate (pentamethylene diisocyanate, PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H₁₂MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′- and 4,4′-MDI or mixtures thereof), diisocyanatomethylbenzene (tolylene 2,4- and 2,6-diisocyanate, TDI) and technical grade mixtures of the two isomers, and 1,3- and/or 1,4-bis(isocyanatomethyl)benzene (XDI), 3,3′-dimethyl-4,4′-biphenyl diisocyanate (TODI), paraphenylene 1,4-diisocyanate (PPDI) and cyclohexyl diisocyanate (CHDI) and the oligomers of higher molecular weight which are obtainable individually or in a mixture from the above and have biuret, uretdione, isocyanurate, iminooxadiazinedione, allophanate, urethane and carbodiimide/uretonimine structural units. Preference is given to the use of polyisocyanates based on aliphatic and cycloaliphatic diisocyanates.

The at least one polyisocyanate is preferably selected from di- or triisocyanates, such as butane 1,4-diisocyanate, pentamethylene diisocyanate, hexamethylene diisocyanate, 4-isocyanatomethyloctane 1,8-diisocyanate, 4,4′-methylenebis(cyclohexyl isocyanate), decamethylene 1,10-diisocyanate, 3,5,5-trimethyl-1-isocyanato-3-isocyanatomethylcyclohexane, 1,3- and 1,4-bis(isocyanatomethyl)cyclohexane, isophorone diisocyanate, naphthalene 1,5-diisocyanate, diisocyanatodiphenylmethane, such as 2,2′-, 2,4′- and 4,4′-MDI or mixtures thereof, diisocyanatomethylbenzene, such as tolylene 2,4- and 2,6-diisocyanate, and technical grade mixtures of the two isomers, and 1,3- and/or 1,4-bis(isocyanatomethyl)benzene, 3,3′-dimethyl-4,4′-biphenyl diisocyanate, paraphenylene 1,4-diisocyanate and cyclohexyl diisocyanate and the oligomers of higher molecular weight which are obtainable individually or in a mixture from the above and have biuret, uretdione, isocyanurate, iminooxadiazinedione, allophanate, urethane and carbodiimide/uretonimine structural units, preferably polyisocyanates based on aliphatic and cycloaliphatic diisocyanates are used, more preferably the at least one polyisocyanate A2 is selected from hexamethylene diisocyanate, pentamethylene diisocyanate and isophorone diisocyanate.

The second component further contains at least one compound of the formula (I)

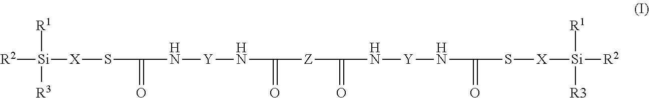

where
R¹ to R³ each independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably in each case alkyl radicals which have up to 6 carbon atoms and/or alkoxy radicals which have up to 6 carbon atoms and may contain up to 3 oxygen atoms, particularly preferably in each case methyl, methoxy and/or ethoxy, with the proviso that at least one of the radicals R¹, R² and R³ is joined to the silicon atom via an oxygen atom,
X independently at each instance are identical or different, saturated or unsaturated, linear or branched, aliphatic or cycloaliphatic or optionally substituted aromatic or araliphatic radicals which have up to 6 carbon atoms, preferably linear alkyl radicals having 1 to 4 carbon atoms, particularly preferably is a propylene radical (—CH₂—CH₂—CH₂—);
Y independently at each instance are identical or different, saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably selected from isophoronyl, pentamethylene, hexamethylene, biscyclohexylmethylene, toluidenyl or methylenediphenylene; and
Z is a structural unit which is derived from an at least difunctional polyol having a number-average molecular weight Mₙ of 270 to 22 000 g/mol, preferably of 500 to 18 000 g/mol and particularly preferably of 800 to 12 000 g/mol;
   or
   is a polyhydric alcohol and/or ether alcohol or ester alcohol containing 2 to 14 carbon atoms, preferably 4 to 10 carbon atoms.

Suitable and preferred difunctional polyols from which the structural unit Z in formula (I) can be derived are the (polymeric) polyols already described above in the text, the same preferences applying here. Suitable and preferred polyols and silane-functional prepolymers obtained therefrom are the polyols disclosed in WO 2018/029197 A1, which can preferably be prepared by the processes described in said document.

Alternatively to the above definition of Z in formula (I), in a further embodiment Z is a structural unit which is derived from a polyhydric alcohol and/or ether alcohol or ester alcohol as polyol which contains 2 to 14 carbon atoms, preferably 4 to 10 carbon atoms.

Such polyols, also referred to as low molecular weight polyols, suitable alternatively to the above definition of Z in formula (I) are polyhydric alcohols and/or ether alcohols or ester alcohols such as, for example, ethane-1,2-diol, propane-1,2- and -1,3-diol, the isomeric butanediols, pentanediols, hexanediols, heptanediols and octanediols, decane-1,10-diol, dodecane-1,12-diol, cyclohexane-1,2- and -1,4-diol, cyclohexane-1,4-dimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), propane-1,2,3-triol, butane-1,2,4-triol, 1,1,1-trimethylolethane, hexane-1,2,6-triol, 1,1,1-trimethylolpropane (TMP), bis(2-hydroxyethyl)hydroquinone, 1,2,4- and 1,3,5-trihydroxycyclohexane, 1,3,5-tris(2-hydroxyethyl) isocyanurate, bis(hydroxymethyl)tricyclo[5.2.1.0^{2,6}]decane, 4,8-bis(hydroxymethyl)tricyclo[5.2.1.0^{2,6}]decane and 5,8-bis(hydroxymethyl)tricyclo[5.2.1.0′]decane containing, where the compounds may be present individually or in an isomer mixture. Ditrimethylolpropane, 2,2-bis(hydroxymethyl)propane-1,3-diol (pentaerythritol), 2,2,6,6-tetrakis(hydroxymethyl)-4-oxaheptane-1,7-diol (dipentaerythritol), mannitol or sorbitol, low molecular weight ether alcohols such as diethylene glycol, triethylene glycol, tetraethylene glycol, dipropylene glycol or dibutylene glycol or low molecular weight ester alcohols such as neopentyl glycol hydroxypivalate.

Preferred examples of such isocyanatosilanes having a thiourethane structure are the reaction products of 2-mercaptoethyltrimethoxylsilane, 2-mercaptoethylmethyldimethoxysilane, 2-mercaptoethyltrimethoxysilane, 2-mercaptoethyltriethoxysilane, 3-mercaptopropylmethyldimethoxysilane, 3-mercaptopropyldimethylmethoxysilane, 3-mercaptopropyltrimethoxysilane, 3-mercaptopropylmethyldiethoxysilane, 3-mercaptopropylethyldimethoxysilane, 3-mercaptopropylethyldiethoxysilane and/or 4-mercaptobutyltrimethoxysilane with 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

Particularly preferred alkoxysilane-functional isocyanates of the present invention are isocyanatomethyltrimethoxysilane, isocyanatomethyltriethoxysilane, 3-isocyanatopropyltrimethoxysilane and 3-isocyanatopropyltriethoxysilane, the isocyanatosilanes having a thiourethane structure obtainable by the process of WO 2014/037279 A1 by reaction of 3-mercaptopropyltrimethoxysilane and/or 3-mercaptopropyltriethoxysilane with 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane and any desired mixtures of such isocyanatosilanes.

The use of the mentioned isocyanatosilanes having a thiourethane structure is very particularly preferred.

The second component can optionally also contain at least one solvent. The solvents as above for the first component are also suitable here. In addition, the preferred embodiments for the first component are likewise preferred for the second component.

The second component can optionally contain at least one compound (D2) which differs from the compound of formula (I) and is obtained by reacting at least one isocyanate group with a secondary amine containing a silane group.

Preferred compounds for the component D2 have the general formula (II)

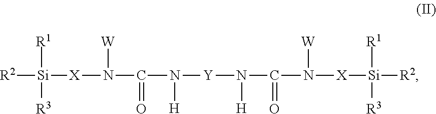

where
R¹, R² and R³ independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, preferably in each case alkyl radicals which have up to 6 carbon atoms and/or alkoxy radicals which have up to 6 carbon atoms and may contain up to 3 oxygen atoms, particularly preferably in each case methyl, methoxy and/or ethoxy, with the proviso that at least one of the radicals R¹, R² and R³ is joined to the silicon atom via an oxygen atom,
X is a linear or branched organic radical having up to 6, preferably 1 to 4, carbon atoms, particularly preferably a propylene radical (—CH₂—CH₂—CH₂—) and
Y is a linear or branched, aliphatic or cycloaliphatic radical having 4 to 18 carbon atoms or an optionally substituted aromatic or araliphatic radical having 6 to 18 carbon atoms, preferably a linear or branched, aliphatic or cycloaliphatic radical having 6 to 13 carbon atoms, and
W independently at each instance is a formyl or acetyl group or else a COO group having a radical G, G in this case may be mono-, di-, tri- or tetrafunctional and is a linear or branched, aliphatic or cycloaliphatic radical or a connecting unit derived therefrom having 4 to 18 carbon atoms or an optionally substituted aromatic or araliphatic radical or a connecting unit derived therefrom having 6 to 18 carbon atoms, preferably a linear or branched, aliphatic or cycloaliphatic radical having 6 to 13 carbon atoms. The radical W can optionally contain one or more heteroatoms selected from the group of oxygen, sulfur and nitrogen.

Alternatively suitable compounds (D2) are obtained by reacting at least one isocyanate group with a secondary amine containing a silane group, with suitable secondary amines containing a silane group being for example aspartic esters, as described in EP-A-0 596 360. In these molecules of the general formula (III),

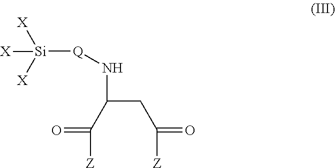

X independently at each instance is selected from alkoxy or alkyl radicals, or two radicals X together with the silicon atom to which they are bonded form an Si-substituted hydrocarbon ring, each having up to 10 carbon atoms, with the proviso that the Si atom has at least one alkoxy radical,
Q is a difunctional linear or branched aliphatic radical having up to 10 carbon atoms, preferably is —CH₂— or —(CH₂)₃—, in particular is —(CH₂)₃—; and
Z at each instance is an alkoxy radical having 1 to 10 carbon atoms.

The use of such aspartic esters is preferred. Examples of particularly preferred aspartic esters are diethyl N-(3-triethoxysilylpropyl)aspartate, diethyl N-(3-trimethoxysilylpropyl)aspartate and diethyl N-(3-dimethoxymethylsilylpropyl)aspartate. The use of diethyl N-(3-triethoxysilylpropyl)aspartate is very particularly preferred.

These suitable and preferred secondary amines containing a silane group can be reacted with any desired polyisocyanates to form the polyurea prepolymers (D2). Preference is given to polyurea prepolymers (D2) prepared from compounds of the formula (III), as described and prepared in EP-A-0 994 117.

The first and the second component are preferably reacted in an NCO—OH ratio of 1:1.2 to 1.2:1, especially 1:1.

For the formulation of coatings, sealants or adhesives, the silane group-containing polyurethanes according to the invention can also be supplemented with any desired further customary auxiliaries and additives, for example UV stabilizers (see above), antioxidants (see above), water scavengers, slip additives, defoamers, leveling agents, rheology additives, flame retardants, fillers and/or pigments. In addition to use as sole binders, the process products according to the invention can also be added, for example as an additive, to standard 1-component or 2-component polyurethane systems, for example in order to achieve very specific properties, for example for improvement of adhesion.

The application of the coatings, paints, sealants or adhesives formulated using the silane group-containing polyurethane according to the invention may be effected by methods known per se, for example by spraying, brushing, dipping, flow-coating, or with the aid of rollers or knife coaters, in one or more layers. Possible substrates are any desired substrates, for example metal, wood, glass, stone, ceramic materials, concrete, hard and flexible plastics, textiles, leather and paper, which may optionally also be provided with customary primers prior to coating.

The invention accordingly also provides the abovementioned substrates coated with silane group-containing polyurethanes according to the invention.

The coatings are preferably applied in a temperature range from 0° C. to 120° C., more preferably between 15° C. and 90° C.

Reaction of the 2-component system affords a silicon-containing polyurethane.

### EXAMPLES

The examples which follow serve to illustrate the present invention, but should in no way be understood as imposing any restriction on the scope of protection.

All reported percentages are based on weight unless otherwise stated.

All experiments were conducted at 23° C. and 50% relative humidity.

NCO contents were determined titrimetrically in accordance with DIN EN ISO 11909:2007-05.

The solids content was determined in accordance with DIN EN ISO 3251:2008-06.

All viscosity measurements were made with a Physica MCR 51 rheometer from Anton Paar Germany GmbH (Germany) to DIN EN ISO 3219/A:1994-10.

The residual monomer contents were measured in accordance with DIN EN ISO 10283:2007-11 by gas chromatography using an internal standard.

OH numbers were determined by titrimetry in accordance with DIN 53240-2: 2007-11, acid numbers in accordance with DIN EN ISO 2114:2002-06. The OH contents reported were calculated from the OH numbers determined by analysis. The reported values in each case relate to the total weight of the respective composition including any solvent also used.

The doubling of the flow times, customarily to be determined in accordance with DIN EN ISO 2431:2011-11 (“Determination of flow time with flow cups”) was not used to determine the pot life, and instead the skin formation time of the moisture-curing STP was used. By periodically touching the film surface with the end of a wooden spatula, the time at which skin adhering to the spatula tip could be pulled up from the surface was determined.

The drying times (T1, T3 and T4) were determined in accordance with DIN EN ISO 9117-5:2010-07 (drying test part 5: modified Bandow-Wolff method).

Solvent and water resistances were ascertained to DIN EN ISO 4628-1:2016-07. The solvent resistance test was carried out using the solvents xylene (also abbreviated hereinafter to “Xy”), methoxypropyl acetate (also abbreviated hereinafter to “MPA”), ethyl acetate (also abbreviated hereinafter to “EA”), and acetone (also abbreviated hereinafter to “Ac”). The contact time was 5 min in each case. For measurement of the water resistances, the contact time was 24 h in each case. The inspection was conducted according to the specified standard. The test surface is assessed visually and by scratching, using the following classification: 0=no change apparent; 1=swelling ring, hard surface, only visible change; 2=swelling ring, slight softening; 3=distinct softening (possibly slight blistering); 4=significant softening (possibly severe blistering), can be scratched through to the substrate; 5=coating completely destroyed without outside influence.

König pendulum damping was determined in accordance with DIN EN ISO 1522:2007-04 on glass plates. The STP films described were applied onto glass plates using a coating blade. The dry film thickness was 35-40 μm for all films.

All STP films described were applied onto glass plates using a coating blade. The film thickness was 35-40 μm for all films.

### LIST OF TRADE NAME AND ABBREVIATIONS

Borchi Kat 22 (zinc carboxylate-based catalyst, 100%) was obtained from Borchers.

Setalux DA HS 1170 BA (OH content 3.6%, solids content 70%, viscosity 1200 mPa·s) and Setalux DA 870 BA (OH content 3.6%, solids content 70%, viscosity 1200 mPa·s) polyacrylate from Allnex.

Stabaxol 1 tetraisopropyldiphenylcarbodiimide from RheinChemie. Methoxypropyl acetate (MPA), butyl acetate (BA), ethyl acetate (EA), acetone (Ac) and xylene (Xy) were obtained from Azelis.

Hexamethylene diisocyanate (HDI), Desmodur XP 2565 (IPDI allophanate, 80% solids content, NCO content 12%, viscosity 2.800 mPa·s) was obtained from Covestro.

Dibutyltin dilaurate (DBTL) was obtained from RheinChemie, available under the trade name Addocat 201 40P. Mercaptopropyltrimethoxysilane, orthophosphoric acid, tetraethyl orthoformate (TEOF), aminopropyltriethoxysilane and diethyl maleate were obtained from Sigma-Aldrich.

Leveling agents such as BYK-141 and BYK-311 were obtained from BYK Additives & Instruments.

Light stabilizers such as Tinuvin 292 and Tinuvin 1130 were obtained from BASF.

Black basecoat (Permahyd®, Base Coat 280) was used from Spiess Hecker.

All reagents and chemicals were used without further purification.

Synthesis of the Crosslinking Raw Materials

### Preparation Example 1

A glass reactor was charged with 934 g of HDI to which 1.3 g of Borchi Kat 22 were added. 364 g of 3-mercaptopropyltrimethoxysilane were then added dropwise. The reaction solution was stirred until an NCO content of 24% by weight was reached. After addition of orthophosphoric acid (20% in i-PrOH), the unconverted monomeric HDI was removed by means of two-stage thin-film distillation at a temperature of 130° C. and a pressure of 0.1 mbar.

NCO=11.2%

Solids content=100% by weight

Viscosity=515 mPa·s

### Preparation Example 2

764.91 g of 2-Setalux DA HS 1170 BA and 38.83 g of Stabaxol 1 are added to 478.03 g of the obtained compounds from preparation example 1, 15.02 g of TEOF and 10 drops of DBTL at 80° C. under dry nitrogen and the reaction is conducted until a residual NCO content of <0.3% is reached. 203.21 g of BuAc are added to the crude product. A virtually colorless, clear silane is obtained.

NCO residual content: 0.26%

Viscosity (23° C.): 723 mPa·s

Solids content: 70%

### Preparation Example 3

The HDI polyisocyanate used here was prepared in accordance with example 11 of EP-A 330 966. The reaction was stopped by adding dibutyl phosphate at an NCO content of the crude product of 40%. Subsequently, unconverted HDI was removed by means of thin-film evaporation at a temperature of 130° C. and a pressure of 0.2 mbar. A product was obtained with the following properties:

NCO content: 21.8%

Viscosity (23° C.): 3000 mPa·s

Solids content=100% by weight

Monomeric HDI: 0.1%

Resin Formulations

### Example 4 (Comparative Example)

47.4 g of Setalux DA 870 BA were mixed with 0.25 g of BYK-141, 1.48 g of BYK-311, 0.99 g of Tinuvin 292, 1.97 g of Tinuvin 1130, 3 g of Addocat 201 and 20.33 g of a mixture of butyl acetate/MPA/xylene (1:1:1). After addition of a mixture of 15.91 g of preparation example 3 and 8.72 g of butyl acetate/xylene (1:1), the mixture was coated onto a black basecoat (Spiess Hecker, Permahyd®, Base Coat 280) and heated at 60° C. for 30 min for curing.

### Example 5

40.61 g of Setalux DA 870 BA were mixed with 0.21 g of BYK-141, 1.27 g of BYK-311, 0.84 g of Tinuvin 292, 1.69 g of Tinuvin 1130, 2.57 g of Addocat 201 and 21.42 g of a mixture of butyl acetate/MPA/xylene (1:1:1). After addition of a mixture of 13.63 g of preparation example 3, 14.29 g of the compound from preparation example 2 and 7.47 g of butyl acetate/xylene (1:1), the mixture was coated onto a black basecoat (Spiess Hecker, Permahyd®, Base Coat 280) and heated at 60° C. for 30 min for curing.

### Use Examples

When adding STPs to 2K PU coating formulations, it was surprisingly observed that an extension of the pot life can be achieved. The addition of 10% by weight of an STP with various structures is sufficient for a 40%-70% increase in the pot life (table 1). This makes it possible to increase the processing time for a 2K PU formulation. In addition, an improved scratch resistance for the same gloss retention in weathering is observed (vide infra).

TABLE 1
Pot life extension of 2K PU systems compared
to STP-containing 2K PU formulations. Catalyst: DBTL
(0.1% by weight) used. Doubling of the viscosity at RT.

| No. | | Pot life (h) |
|---|---|---|
| 1 | 2K PU (comparative example 4) | 1.5 |
| 2 | 2K PU + 10% STP (example 5) | 2.4 |

The addition of 10% by weight of an STP (based on the solids content) had a minor influence on the pendulum hardness of the coating film (table 2). The solvent resistances of the various 2K PU coating films with added STP correspond to those of the comparative system (No. 1). The gloss values (60° C.) gave values comparable to the comparative system. It was observed that the scratch resistance of the coating systems can be improved by addition of an STP.

TABLE 2

| | | | Scratch | Scratch |
|---|---|---|---|---|
| | | | resistance | resistance |
| | | Solvent | zero value | final value |
| | Pendulum | resistance | Gloss | Gloss |
| | hardness | (Xy/MPA/ | measurement | measurement |
| | (s) | EA/Ac)* | (60°) | (60°) |
| Comparative | 159 | 0 1 3 5 | 91.2 | 48.9 |
| example 4 | | | | |
| Example 5 | 115 | 0 2 3 5 | 91.0 | 60.5 |

*Xy = xylene,
MPA = methoxypropyl acetate,
EA = ethyl acetate,
Ac = acetone

The addition of STPs to extend the pot life of a 2K PU formulation has no influence on the weathering resistance since the STP-containing clearcoats exhibit no changes whatsoever over a period of 1000 h in the CAM 180 test. This finding is confirmed by the gloss measurement at different angles before and after the weathering period.

TABLE 3
Weathering study (CAM 180) after 1000 h

| | | Gloss | Gloss |
|---|---|---|---|
| | Visual | measurement | measurement |
| | inspection | 0 h | 1000 h |
| | (1000 h) | (20°/ 60°) | (20°/60°) |
| Comparative | No change | 92/94 | 91/95 |
| example 4 | | | |
| Example 5 | No change | 91/93 | 91/94 |

1. A 2-component system comprising
a first component, which comprises:
A1) at least one compound having at least one Zerewitinoff-active group;
B1) optionally at least one catalyst;
C1) optionally at least one solvent; and
D1) optionally at least one additive,
and
a second component, which comprises:
A2) at least one polyisocyanate; and
B2) at least one of the following compounds of the formula (I): 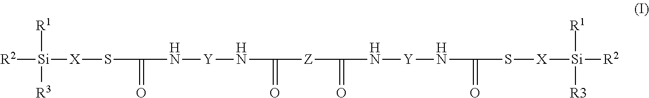
where
R¹ to R³ each independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, wherein at least one of the radicals R¹, R² and R³ is joined to the silicon atom via an oxygen atom,
X independently at each instance is identical or different, saturated or unsaturated, linear or branched, aliphatic or cycloaliphatic or optionally substituted aromatic or araliphatic radicals which have up to 6 carbon atoms;
Y independently at each instance are identical or different, saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen; and
Z is a structural unit which is derived from an at least difunctional polyol having a number-average molecular weight Mₙ of 270 to 22 000 g/mol;
or
is a polyhydric alcohol and/or ether alcohol or ester alcohol containing 2 to 14 carbon atoms;
C2) optionally at least one solvent;
D2) optionally at least one compound which differs from the compound of formula (I) and is obtained by reacting at least one isocyanate group with a secondary amine containing a silane group.

2. The 2-component system of claim 1, wherein the at least one compound A1 is selected from the group consisting of polyols, polyamines, polyether polyols, polyester polyols, polyurethane polyols, polysiloxane polyols, polycarbonate polyols, polyether polyamines, polybutadiene polyols, polyacrylate polyols and polymethacrylate polyols and copolymers thereof.

3. The 2-component system of claim 1, wherein the at least one catalyst B1 is selected from the class of tin catalysts, bismuth catalysts, zinc catalysts, zirconium catalysts and amine bases.

4. The 2-component system of claim 1, wherein the at least one solvent C1 is selected from aromatic solvents and aliphatic solvents, and mixtures thereof.

5. The 2-component system of claim 1, wherein the at least one additive D1 is selected from UV stabilizers, antioxidants and leveling agents, or mixtures thereof.

6. The 2-component system of claim 1, wherein the at least one polyisocyanate A2 is selected from the group consisting of di- or triisocyanates, such as butane 1,4-diisocyanate, pentamethylene diisocyanate, hexamethylene diisocyanate, 4-isocyanatomethyloctane 1,8-diisocyanate, 4,4′-methylenebis(cyclohexyl isocyanate), decamethylene 1,10-diisocyanate, 3,5,5-trimethyl-1-isocyanato-3-isocyanatomethylcyclohexane, 1,3- and 1,4-bis(isocyanatomethyl)cyclohexane, isophorone diisocyanate, naphthalene 1,5-diisocyanate, diisocyanatodiphenylmethane, such as 2,2′-, 2,4′- and 4,4′-MDI or mixtures thereof, diisocyanatomethylbenzene, such as tolylene 2,4- and 2,6-diisocyanate, and technical grade mixtures of the two isomers, and 1,3- and/or 1,4-bis(isocyanatomethyl)benzene, 3,3′-dimethyl-4,4′-biphenyl diisocyanate, paraphenylene 1,4-diisocyanate and cyclohexyl diisocyanate and the oligomers of higher molecular weight which are obtainable individually or in a mixture from the above and have biuret, uretdione, isocyanurate, iminooxadiazinedione, allophanate, urethane and carbodiimide/uretonimine structural units.

7. The 2-component system of claim 1, wherein D2 is selected from
i) at least one compound of the formula (II) 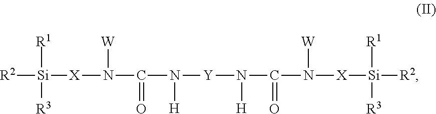
where
R¹, R² and R³ each independently of one another are identical or different saturated or unsaturated, linear or branched, aliphatic or cycloaliphatic or optionally substituted aromatic or araliphatic radicals which have up to 18 carbon atoms and may optionally contain up to 3 heteroatoms from the group of oxygen, sulfur, nitrogen, with the proviso that at least one of the radicals R¹, R² and R³ is joined to the silicon atom via an oxygen atom,
X is a linear or branched organic radical having up to 6 carbon atoms and
Y is a linear or branched, aliphatic or cycloaliphatic radical having 4 to 18 carbon atoms,
W independently at each instance are a formyl or acetyl group or else a COO group having a radical G, G in this case may be mono-, di-, tri- or tetrafunctional and is a linear or branched, aliphatic or cycloaliphatic radical or a connecting unit derived therefrom having 4 to 18 carbon atoms or an optionally substituted aromatic or araliphatic radical, or
ii) at least one compound of the formula (III) 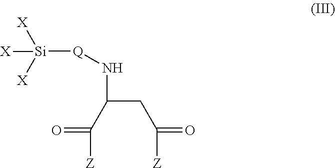
where
X independently at each instance is selected from alkoxy or alkyl radicals, or two radicals X together with the silicon atom to which they are bonded form an Si-substituted hydrocarbon ring, each having up to 10 carbon atoms, wherein the Si atom has at least one alkoxy radical,
Q is a difunctional linear or branched aliphatic radical having up to 10 carbon atoms;
and
Z at each instance is an alkoxy radical having 1 to 10 carbon atoms.

8. The 2-component system of claim 1, wherein B2 has an isocyanate content of less than 2%.

9. The 2-component system of claim 1, wherein the constituents of the first component parts by weight of A1 and parts by weight of B1 are present in a weight ratio of 0.5 to 8 in relation to the constituents parts by weight of C1 and parts by weight of D1.

10. The 2-component system of claim 1, wherein the constituents of the second component parts by weight of A2 and parts by weight of B2 are present in a weight ratio of 0.5 to 10 to the constituents parts by weight of C2 and parts by weight of D2.

11. The 2-component system of claim 1, wherein the constituents of the first component parts by weight of A1, and optionally parts by weight of B1, parts by weight of C1 and parts by weight of D1, are present in a weight ratio of 0.6 to 11 to the constituents of the second component, parts by weight of A2, parts by weight of B2 and optionally parts by weight of C2 and parts by weight of D2.

12. A process for preparing silicon-containing polyurethanes, comprising reacting the first component with the second component of the 2-component system of claim 1.

13. A silicon-containing polyurethanes product produced by the process of claim 12.

14. (canceled)

15. A coating, sealant or adhesive produced from the 2-component system of claim 1.
